(19) United States
(12) Patent Application Publication
(10) Pub. No.: US 2017/0253824 A1
(43) Pub. Date: Sep. 7, 2017

(54) METHOD FOR PREPARING TWO-DIMENSIONAL HYBRID COMPOSITE

(71) Applicant: Korea Institute of Ceramic Engineering and Technology, Jinju-si, Gyeongsangnam-do (KR)

(72) Inventor: Seung Hun HUH, Seoul (KR)

(21) Appl. No.: 14/916,388

(22) PCT Filed: Nov. 5, 2015
(86) PCT No.: PCT/KR2015/011833

§ 371 Date: Mar. 3, 2016

(30) Foreign Application Priority Data
Oct. 13, 2015 (KR) 10-2015-0142682

(51) Int. Cl. C10M 103/02; H01B 1/04; B01J 35/00; C10M 103/06; B01J 27/051

(52) U.S. Cl. CPC C10M 103/02; C10M 103/06; B01J 27/051; B01J 35/004; H01B 1/04; C10M 2201/0413; C10M 2201/066; C10M 2201/065

(57) ABSTRACT

The present invention relates to a method for preparing a two-dimensional hybrid composite that is capable of solving the problems with the two-dimensional plate type materials, that is, step difference, defects, stretching, etc., that occur as the second-dimensional plate type materials overlap with one another. The present invention provides a method for preparing a two-dimensional hybrid composite that includes: (a) preparing a first plate type material in the solid or liquid state; (b) mixing a second plate type material with the first plate type material, the second plate type material being thinner and more flexible than the first plate type material; (c) mixing a solid or liquid binder with the first and second plate type materials to make the first and second plate type materials partly contact with or apart from each other; and (d) solidifying a composite formed by the steps (a), (b) and (c).

### TECHNICAL FIELD

The present invention relates to a method for preparing a two-dimensional hybrid composite that solves the problems with second-dimensional plate type materials, that is, step difference, defects, etc., that occur as the second-dimensional plate type materials overlap with one another.

### BACKGROUND ART

Plate type materials include ceramic nanoplates (e.g., nanoclay, ZnO nanoplate, TiO₂ nanoplate, WS₂, MoS₂, oxides, clamshell, calcium carbonate, sulfides, etc.), metal flakes (e.g., silver flake, copper flake, etc.), graphite, carbon nanoplate, graphene, graphene nanoplate, graphene oxides, and so forth. Composite compounds, organic-inorganic hybrid materials, or the like are also available in the plate form.

These plate type materials are importantly used in the fields of enhancers for strengths (e.g., bending strength, tensile strength, etc.), electrical conductivity, and thermal conductivity, fillers, gas barriers, lubricants (solid or liquid), liquid heat transfer bodies, or the like.

The plate type materials are largely classified into non-graphite plate type materials (e.g., ceramic nanoplate, metal flake, composite compounds, organic-inorganic hybrid materials, etc.) and graphite plate type materials (e.g., graphite (e.g., carbon flake, amorphous graphite, plate type graphite, flake graphite, artificial graphite, etc.), carbon nanoplate, graphene, graphene oxide, graphite oxide, etc.).

The non-graphite plate type materials are normally about 5 nm in thickness. Further, WS₂ and MOS₂ that are of great importance as a solid lubricant can be prepared under control so that the nanoplate has a given number of layers or less.

As for the graphite plate type materials, graphite is 100 nm or greater in thickness; and graphene or graphene oxide is approximately 5 to 7 nm (1 to 20 layers) or less in thickness.

More specifically, graphite has a thick planar structure with the layers bonded together via weak van der Waals bonds. In the grinding process, the van der Waals bonds are broken to make the graphite thinner. But it is difficult to make the thickness of the graphite as thin as 100 nm or less.

Carbon nanoplate (hereinafter, referred to as “CNP”) has a very thin structure, usually thinner than graphite, and its thickness ranges from about 5 nm to 200 nm.

On the other hand, a plate type material can also be prepared using a graphite intercalated compound (GIC) that includes chemical species inserted between the graphite layers. In other words, the GIC is heated at appropriate temperature or exposed to microwave to cause an interlayer expansion of the graphite, making an expanded graphite (hereinafter, referred to as “EG”) having a long larva-like form. The layers (that is, nanoplates) of the EG with weak internal bonds are taken apart from one another by way of mechanical treatment, sonication, chemical treatment, application of shear force, ball milling, and so forth to yield a plate type material (hereinafter, referred to as “EP”). EP is of course classified as a carbon nanoplate, and the present invention specifies the concept that carbon nanoplate includes EP.

Unlike the graphite or CNP, graphene (hereinafter, referred to as “GP”) is a novel material having a very thin carbon nanostructure with quantum-mechanical properties. GP is known as a material that is far superior to any other existing natural or artificial materials in regards to the properties, including electrical conductivity, thermal conductivity, strengths, flexibility, gas barrier properties, or the like. Particularly, GP is flexible and stretchable at once, so it can be stretched by up to 30%, but with maintained strengths, electrical conductivity and thermal conductivity. The thickness of GP is about 5 to 7 nm or less, considering that GP normally has 1 to 20 honeycomb-like layers made of carbon atoms, with the interlayer spacing of about 3.4 nm.

Graphene oxide (hereinafter, referred to as “GO”) or graphite oxide (also referred to as “GO”; that is, the term “GO” as used in this specification refers to both graphene oxide and graphite oxide) is made from graphite and then reduced in the liquid, gas, or solid state into graphene. The reduction method in this case is divided into thermal reduction and chemical reduction. Graphene can also be made from the graphene oxide upon exposure to energy (e.g., microwave, photon, IR, laser, etc.).

Further, graphene can be immersed in a solvent having a very high affinity to graphite and then subjected to sonication or the like to make the layers of graphite apart from one another. Specific examples of the solvent as used herein may include GBL, NMP, etc. The graphene is of good quality but difficult to produce.

In addition, there are other methods to prepare graphene from graphite that include chemical synthesis method, bottom production method, chemical splitting and spreading method using carbon nanotubes, etc. Specific examples of the preparation method may include graphite exfoliation using a solvent, mechanical exfoliation (e.g., sonication, milling, gas-phase high-speed blading, etc.), electrical exfoliation, synthesis, and so forth.

In the preparation of graphene by any known method, it is impossible to completely eliminate oxygen radicals from the surface of the graphene. Generally, the oxygen content by the oxygen radicals on the surface of the graphene other than GO is 5 wt. % or less with respect to the carbon backbone. In the present invention, the term “graphene” refers to any graphene material of which the oxygen content by the oxygen radicals on the surface is 5 wt. % or less with respect to the carbon backbone.

FIG. 1 is the conceptual diagram showing the contact cross-section of zero-dimensional materials (particulate), one-dimensional materials (linear) or two-dimensional materials (planar) for the sake of explaining the excellent properties of the second-dimensional plate type materials. As can be seen from FIG. 1, the two-dimensional plate type materials have an overlap of planes that is impossible to find in zero-dimensional materials or one-dimensional materials. The conceptual diagram of FIG. 1 can be explained more specifically with reference to the case of having zero-dimensional materials (powder), one-dimensional materials (fabrics, etc.), or two-dimensional materials (plate type materials) incorporated into a specific matrix. The zero-dimensional materials are needed in a considerably large quantity in order to induce point contacts. Even with many point contacts, the zero-dimensional materials have the minimum transfer of electricity and heat through the point contacts. The one-dimensional materials, even in a small quantity, can have point contacts induced with ease. Using a large quantity of the one-dimensional materials leads to acquisition of line contacts. The one-dimensional materials are therefore more effective to transfer heat and electricity through contacts than the zero-dimensional powder type particles. The representative examples of the one-dimensional materials are silver nanowires and transparent conductive films. But, the two-dimensional plate type materials are ready to have an overlap of planes and thus far superior in thermal conductivity and electrical conductivity to the one-dimensional materials. In conclusion, the two-dimensional plate type materials are considered as a core material useful in many fields of application.

With no direct contact formed between particulate materials, linear materials, or plate type materials, that is, with an addition of a resin, a dispersing agent, an organic material, an inorganic material, an organic-inorganic hybrid material, a third material, or the like, as illustrated in FIG. 2, the particles having an interactive force to each other are those apart from each other at the shortest distance; the linear materials have an interactive linear force to each other; and the plate type materials have an interplanar attraction to each other. Such an interplanar attraction is the most effective in the plate type materials that are apart from each other, even without a direct contact between them. Among the effective interplanar properties of the plate type materials, electrical conductivity (tunneling, electrical breakdown, etc.) can be acquired by loading a weight of several milligrams to provide an effect of preventing a power outage. Similarly, the same principle is applicable to strengths (tensile strength, bending strength, strength at break, strength at high temperature, etc.), thermal conductivity, barriers (against ions, gas, liquids, etc.), and functionality acquisition (surface modification, etc.).

But, the two-dimensional plate type materials having a large thickness may bring about an adverse effect. In other words, when the thick two-dimensional plate type materials make an overlap with each other, there appears a step difference as shown in the mimetic diagram of FIG. 3. The step difference forms an empty space between the two-dimensional plate type materials, making the contact cross section to be a line contact, consequently with deterioration in all the properties, such as electrical conductivity, thermal conductivity, filling rate, barrier properties, membrane density, thickness controllability, membrane uniformity, interface junction, etc. The same problem can be encountered when a third material like a resin is incorporated into the thick plate type materials to form a spatial gap between the plate type materials. For example, graphite is a material very cheap and of great importance in the industrial aspect but its use in electronics, IT, or other developing industries is falling off, for the techniques to enhance the properties of graphite has reached the limit and cannot meet the specifications required in the market, seriously due to a hidden problem like step difference as mentioned above.

Even the two-dimensional plate type material that is thin enough can have the adverse effect, too. In other words, a filmsy piece of the two-dimensional plate type material is ready to get wrinkled and difficult to unfold, as shown in the mimetic diagram of FIG. 4. The wrinkle not only functions as a foreign material but also forms empty spaces serving as defects inside the folds and between the folded materials. This leads to deterioration in the properties, such as electrical conductivity, thermal conductivity, filling rate, barrier properties, membrane density, thickness controllability, membrane uniformity, interface junction, etc. The same problem is also found in the case that a third material like a resin is incorporated into thick plate type materials to form a spatial gap between the plate type materials.

### DISCLOSURE OF INVENTION

It is an object of the present invention to solve the problems in regards to step difference and empty spaces between plate type materials that occur during the complexation process of plate type materials, such as carbon flake, carbon nanoplate (CNP), graphene, graphene oxide, etc. that have a prominent difference in thickness and flexibility.

To achieve the object of the present invention, there is provided a method for preparing a method for preparing a two-dimensional hybrid composite that includes: (a) preparing a first plate type material in the solid or liquid state; (b) mixing a second plate type material with the first plate type material, the second plate type material being thinner and more flexible than the first plate type material; (c) mixing a solid or liquid binder with the first and second plate type materials to make the first and second plate type materials partly contact with or apart from each other; and (d) solidifying a composite formed by the steps (a), (b) and (c).

The first plate type material may include at least one selected from the group consisting of planar ceramic, nanoclay, ZnO nanoplate, TiO₂ nanoplate, WS₂, MoS₂, oxide, clamshell, calcium carbonate, sulfide, metal flake, silver flake, copper flake, carbon flake, carbon nanoplate, graphene, graphene oxide, graphite oxide, a reduced material of graphene oxide, a reduced material of graphite oxide, an electrical exfoliation product of graphite, a physical exfoliation product of graphite, a solvent-based exfoliation product of graphite, a physiochemical exfoliation product of graphite, and a mechanical exfoliation product of graphite.

The second plate type material may include at least one selected from the group consisting of carbon nanoplate, graphene, and graphene oxide, with a thickness of 200 nm or less.

On the other hand, the step (c) may further include adding at least one selected from the group consisting of proteins, amino acids, fats, polysaccharides, monosaccharides, glucose, vitamins, fruit acids, surfactants, dispersing agents, BYK, functional components, solvents, oils, dispersants, acids, bases, salts, ions, labeling agents, cohesive agents, oxides, ceramics, magnetic materials, organic materials, biomaterials, plate type materials, nano-scale plate type materials, nanoparticles, nanowires, carbon nanotubes, nanotubes, ceramic nano-powder, quantum dots, zero-dimensional materials, one-dimensional materials, two-dimensional materials, hybrid materials, organic-inorganic hybrid materials, inks, pastes, and plant extracts.

The present invention also provides a method for preparing a two-dimensional hybrid composite that includes: (a′) preparing a binder; and (b′) attaching a first plate type material and a second plate type material to the surface of the binder, the second plate type material being thinner and more flexible than the first plate type material.

### Effects of the Invention

According to the present invention, the properties of the two-dimensional plate type material can be maximized by providing a solution to the problem of step difference that occurs when the two-dimensional plate type materials overlap with each other. Particularly, the present invention can continuously provide a two-dimensional plate type material with enhanced properties in the fields of electrical conductivity, thermal conductivity, thermal insulation, fillers, barriers, and so forth.

### BRIEF DESCRIPTIONS OF DRAWINGS

FIG. 1 is a cross-sectional conceptual diagram showing the contacts between zero-dimensional materials, one-dimensional materials, or two-dimensional materials.

FIG. 2 is a conceptual diagram showing an interaction when there is a spatial distance between zero-dimensional materials, one-dimensional materials, or two-dimensional materials.

FIG. 3 is a conceptual diagram showing the problem of step difference occurring in two-dimensional plate type materials.

FIG. 4 is a conceptual diagram showing the problem that the two-dimensional plate type material gets wrinkled.

FIG. 5 is a conceptual diagram showing the principle of a solution to the problems such as step difference, wrinkles and empty spaces.

FIGS. 6, 7 and 8 are conceptual diagrams showing the significant effect of plate type materials in combination with a binder.

FIGS. 9, 10 and 11 are conceptual diagrams showing various forms of interaction of plate type materials in combination with a binder (not shown).

FIG. 12 is an FE-SEM image of a graphite/carbon plate hybrid material that overcomes the problem of step difference.

FIG. 13 is an FE-SEM image of a carbon plate/graphene hybrid material that overcomes the problem of step difference.

FIG. 14 is an FE-SEM image of a graphite/carbon plate/graphene hybrid material.

FIG. 15 is an FE-SEM image of a graphite/carbon nanoplate/graphene oxide hybrid plate type material with incorporated silver nanowire and silver nanoparticle.

FIG. 16 is an FE-SEM image of a graphite/carbon nanoplate/graphene oxide hybrid plate type material with an incorporated dispersing agent.

FIG. 17 is an FE-SEM image of a graphite/carbon nanoplate/graphene oxide hybrid plate type material with incorporated silver nanowire and silver nanoparticle.

FIG. 18 is an FE-SEM image of a graphite/carbon nanoplate/graphene oxide hybrid plate type material with an incorporated dispersing agent.

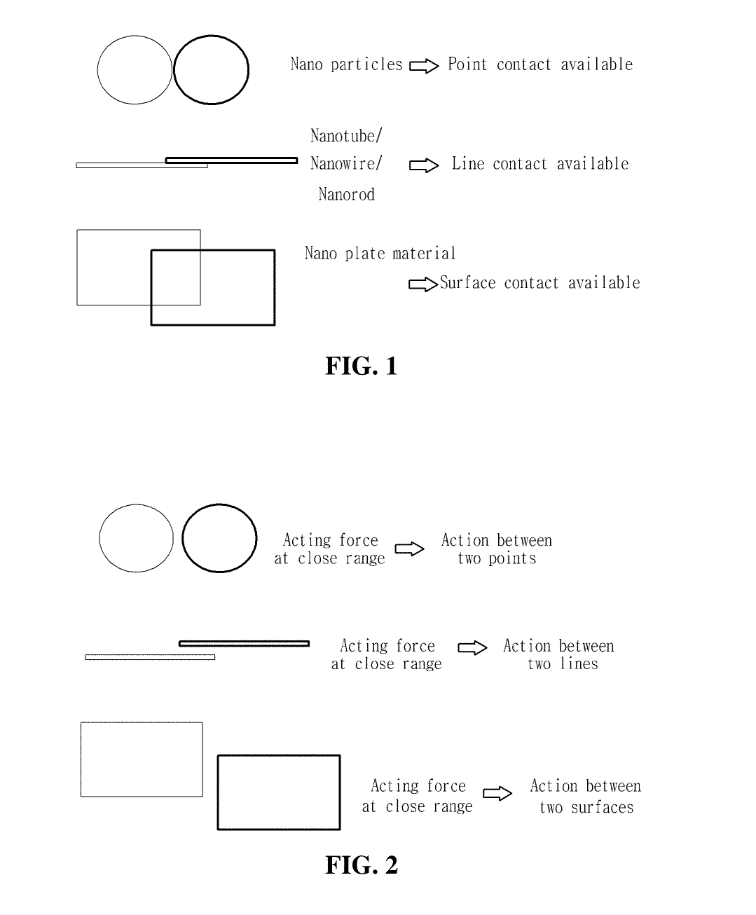

### BEST MODES FOR CARRYING OUT THE INVENTION

The best modes for carrying out a method for preparing a two-dimensional hybrid composite according to the present invention are as follows.

The method for preparing a two-dimensional hybrid composite includes: (a) preparing a first plate type material in the solid or liquid state; (b) mixing a second plate type material with the first plate type material, the second plate type material being thinner and more flexible than the first plate type material; (c) mixing a solid or liquid binder with the first and second plate type materials to make the first and second plate type materials partly contact with or apart from each other; and (d) solidifying a composite formed by the steps (a), (b) and (c).

The first plate type material includes at least one selected from the group consisting of planar ceramic, nanoclay, ZnO nanoplate, TiO₂ nanoplate, WS₂, MoS₂, oxide, clamshell, calcium carbonate, sulfide, metal flake, silver flake, copper flake, carbon flake, carbon nanoplate, graphene, graphene oxide, graphite oxide, a reduced material of graphene oxide, a reduced material of graphite oxide, an electrical exfoliation product of graphite, a physical exfoliation product of graphite, a solvent-based exfoliation product of graphite, a physiochemical exfoliation product of graphite, and a mechanical exfoliation product of graphite.

The second plate type material includes at least one selected from the group consisting of carbon nanoplate, graphene, and graphene oxide, with a thickness of 200 nm or less.

The step (c) further includes adding at least one selected from the group consisting of proteins, amino acids, fats, polysaccharides, monosaccharides, glucose, vitamins, fruit acids, surfactants, dispersing agents, BYK, functional components, solvents, oils, dispersants, acids, bases, salts, ions, labeling agents, cohesive agents, oxides, ceramics, magnetic materials, organic materials, biomaterials, plate type materials, nano-scale plate type materials, nanoparticles, nanowires, carbon nanotubes, nanotubes, ceramic nano-powder, quantum dots, zero-dimensional materials, one-dimensional materials, two-dimensional materials, hybrid materials, organic-inorganic hybrid materials, inks, pastes, and plant extracts.

The conventional solutions to the problem of step difference in the plate type materials are completely replacing the existing materials or enhancing the properties using high-cost techniques. Contrarily, the present invention fundamentally overcomes the issue of step difference simply by making the best use of the good overlap of planes in the two-dimensional plate type materials.

In the present invention, there are deduced four ideas as follows.

(1) Overcoming the issue of step difference by combining plate type materials with a different thickness.

(2) Overcoming the issue of step difference by combining two different plate type materials.

(3) Maximizing the effectiveness with spatial interaction of two plate type materials (first and second plate type materials) that are spatially apart from each other and different in thickness.

(4) Maximizing the planar contact or spatial interaction by solidification of hybrid materials.

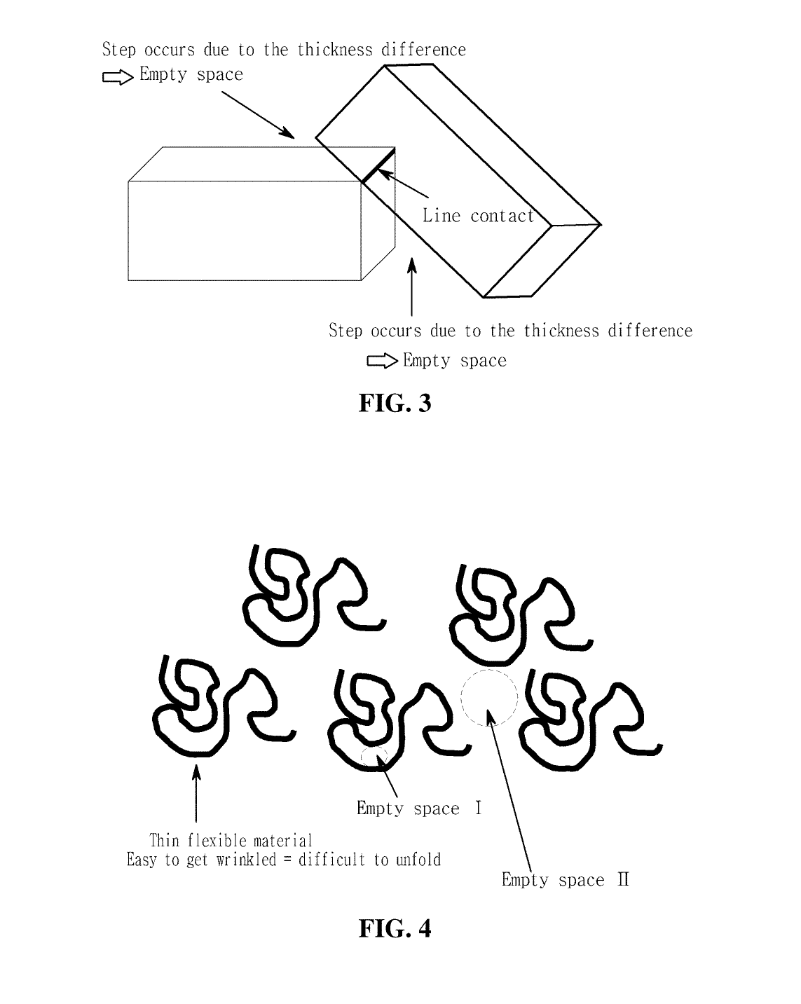

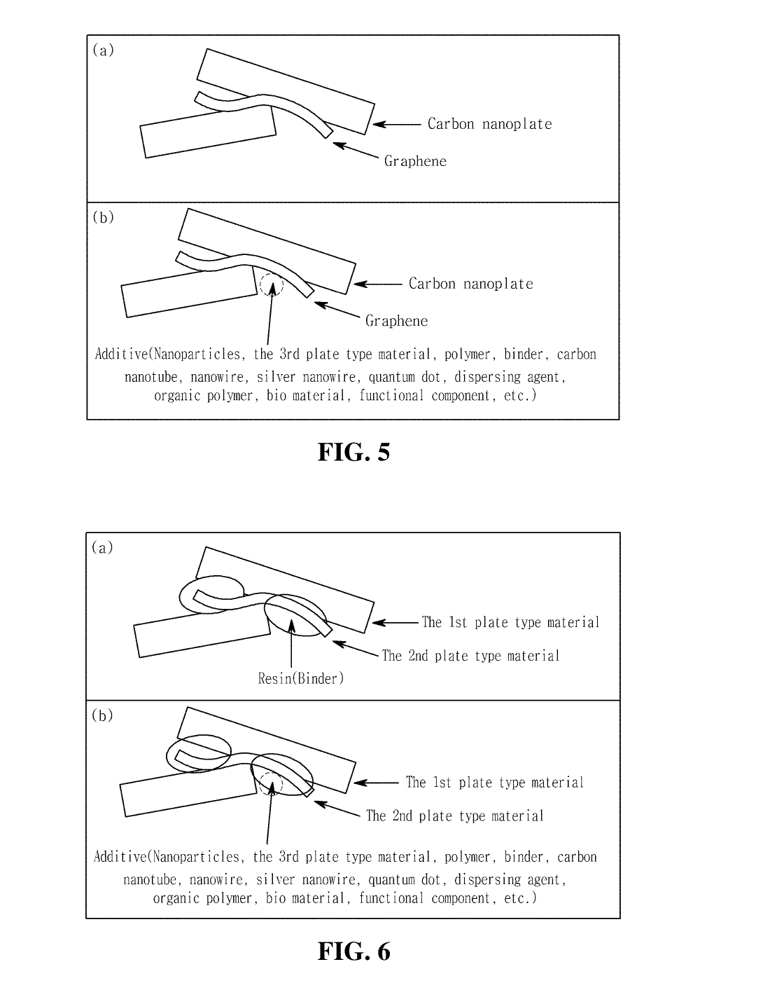

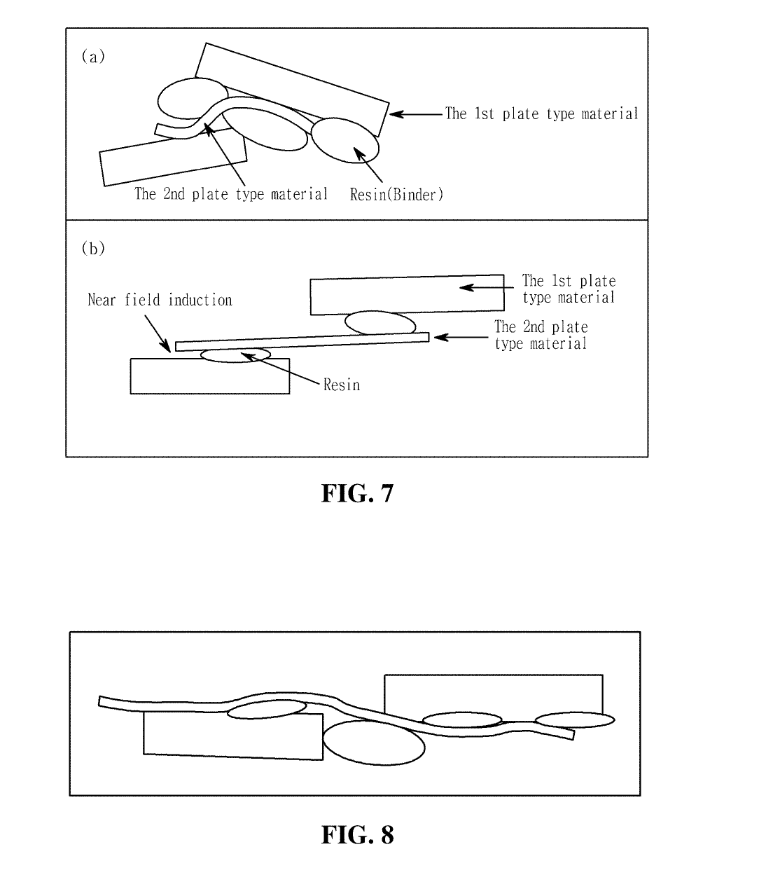

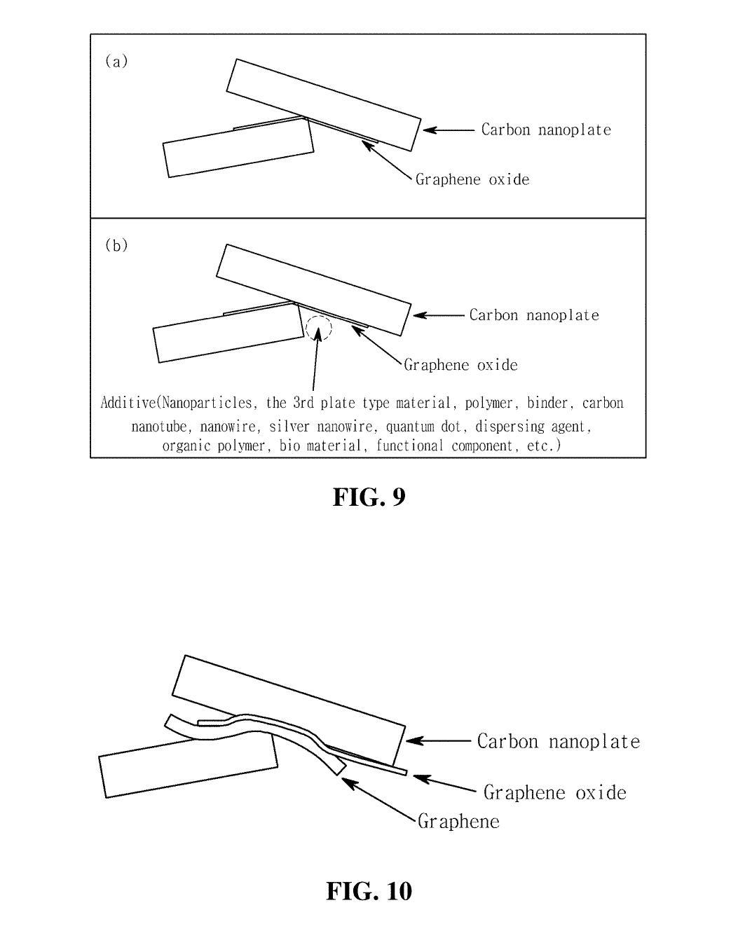

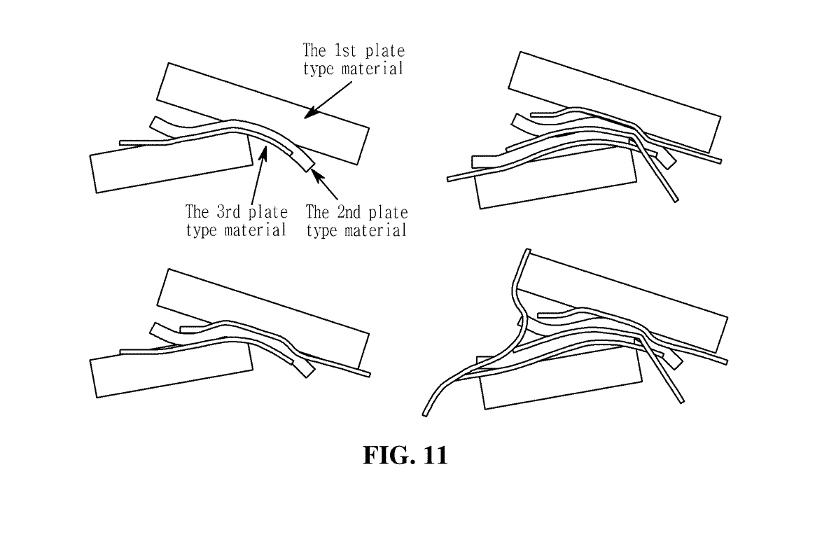

The implicit common factor of the above two ideas is flexibility or ultra-high flexibility of the thin plate type materials. In other words, when the step difference occurs in one plate type material, a material that is thin and very flexible is inserted into the step difference portion and gets in contact with the front and back or top and bottom of the step difference portion, as shown in FIGS. 3, 4 and 5, greatly increasing the interfacial contact area of the step difference portion.

The present invention that has a reflection of the above-mentioned ideas provides a method for preparing a two-dimensional hybrid composite that includes: (a) preparing a first plate type material in the solid or liquid state; (b) mixing a second plate type material with the first plate type material, the second plate type material being thinner and more flexible than the first plate type material; (c) mixing a solid or liquid binder with the first and second plate type materials to make the first and second plate type materials partly contact with or apart from each other; and (d) solidifying a composite formed by the steps (a), (b) and (c). Hereinafter, the present invention will be described in a step-by-step manner.

1. Step (a)

This step is preparing a first plate type material in the solid or liquid state.

The first plate type material may be at least one selected from the group consisting of planar ceramic, nanoclay, ZnO nanoplate, TiO₂ nanoplate, WS₂, MoS₂, oxide, clamshell, calcium carbonate, sulfide, metal flake, silver flake, copper flake, carbon flake, carbon nanoplate, graphene, graphene oxide, graphite oxide, a reduced material of graphene oxide, a reduced material of graphite oxide, an electrical exfoliation product of graphite, a physical exfoliation product of graphite, a solvent-based exfoliation product of graphite, a physiochemical exfoliation product of graphite, and a mechanical exfoliation product of graphite.

2. Step (b)

This step is mixing a second plate type material with the first plate type material, where the second plate type material is thinner and more flexible than the first plate type material.

The second plate type material may be at least one selected from the group consisting of carbon nanoplate, graphene, and graphene oxide, with a thickness of 200 nm or less. Out of these materials, carbon nanoplate and graphene can be used in the applications of thermal conductivity, barriers, strengths, electrical conductivity, solid lubricants, liquid thermal conductors, polymer fillers, etc.

The carbon nanoplate may be prepared by separating layers of the expanded graphite obtained by expansion of graphite intercalated compound (GIC). When used as the second plate type material, carbon nanoplate 5 to 200 nm thick can be added in an amount of 20 wt. % with respect to the total weight.

Further, the flexible plate type material is graphene, which may be prepared by reducing a graphite oxide. The step (b) may involve adding 1 to 20 layers of graphene in an amount of 20 wt. % or less with respect to the total weight.

3. Step (c)

This step is mixing a solid or liquid binder with the first and second plate type materials so that the first and second plate type materials get partly in contact with or apart from each other.

The binder is a material that combines the first and second plate type materials together and may include polymer, resin, binder, curable polymer, monomer, precursor, organic-inorganic hybrid, ceramic sol, silane, siloxane, etc.

The first and second plate type materials and the binder may be hybridized in the solid or liquid state.

The solid hybridization is achieved by the mechanical mixing method and applicable directly to extrusion, ejection, injection, drawing, compression, thermocompression, screw extrusion, pressure extrusion, melt extrusion, solid molding, compression molding, powder molding, cast molding, powder deposition, etc. The raw powder materials are added to a solvent and then exposed to shock waves to maximize dispersion and hybridization.

The liquid hybridization is achieved in a bath of ink, paste, etc. that is, in the liquid state and may further include the steps of blending and applying shock waves.

When the first and second plate type materials are mixed together and dispersed in a solvent, molecule-scale shock waves are applied to make a gap between the plate type materials of the same type, and a plate type material of different thickness or type is inserted into the gap to complete an evenly dispersed two-dimensional hybrid plate type material.

For application of molecule-scale shock waves, there may be used physical energy application methods, such as microcavity method (inducing microcavity explosion), sonication, application of molecule-scale shear force (high-pressure ejection with minute nozzles, high-speed homogenizer method, etc.), ultrahigh-speed blading, ultrahigh-speed stirring, beads ball stirring (stirring with fine beads balls), high-pressure ejection (compression/ejection through minute gaps), high-speed homogenizer method, and so forth. These physical energy application methods may be used alone or in combination. For example, the method of applying high-energy shear force can be used in combination with the sonication method. It is possible to minimize the shock wave application process in a solution, ink, paste, or the like in which nano-scale plate type materials are well dispersed.

The binder may be added in an amount of 1 to 50,000 parts by weight with respect to 100 parts by weight of the first and second plate type materials. For example, a non-aqueous graphene coating solution for manufacture of a transparent conductive film preferably contains to 600 parts by weight of the binder with respect to 100 parts by weight of graphene. The binder as used herein may include at least one selected from the group consisting of (1) thermosetting resins, (2) photocurable resins, (3) silane compounds that are susceptible to hydrolysis and condensation reaction, (4) thermoplastic resins, and (5) conductive polymers.

(1) Thermosetting Resin

The thermosetting resin may include at least one selected from the group consisting of urethane resin, epoxy resin, melamine resin, and polyimide.

(2) Photocurable Resin

The photocurable resin may include at least one selected from the group consisting of epoxy resin, polyethylene oxide, urethane resin, reactive oligomer, reactive monofunctional monomer, reactive difunctional monomer, reactive trifunctional monomer, and photoinitiator.

Reactive Oligomer

The reactive oligomer may include at least one selected from the group consisting of epoxy acrylate, polyester acrylate, urethane acrylate, polyether acrylate, thiolate, organic silicone polymer, and organic silicone copolymer.

Reactive Monofunctional Monomer

The reactive monofunctional monomer may include at least one selected from the group consisting of 2-ethyl hexyl acrylate, octyl decyl acrylate, isodecyl acrylate, tridecyl methacrylate, 2-phenoxyethyl acrylate, nonylphenol ethoxylate monoacrylate, tetrahydrofurfurylate, ethoxyethyl acrylate, hydroxyethyl acrylate, hydroxyethyl methacrylate, hydroxypropyl acrylate, hydroxypropyl methacrylate, hydroxybutyl acrylate, and hydroxybutyl methacrylate.

Reactive Difunctional Monomer

The reactive difunctional monomer may include at least one selected from the group consisting of 1,3-butanediol diacrylate, 1,4-butanediol diacrylate, 1,6-hexanediol diacrylate, diethylene glycol diacrylate, triethylene glycol dimethacrylate, neopentyl glycol diacrylate, ethylene glycol dimethacrylate, tetraethylene glycol methacrylate, polyethylene glycol dimethacrylate, tripropylene glycol diacrylate, and 1,6-hexanediol diacrylate.

Reactive Trifunctional Monomer

The reactive trifunctional monomer may include at least one selected from the group consisting of trimethylolpropane triacrylate, trimethylolpropane trimethacrylate, pentaerythritol triacrylate, glycidyl penta triacrylate, and glycidyl penta trimethacrylate.

Photoinitiator

The photoinitiator may include at least one selected from the group consisting of benzophenone, benzyl dimethyl ketal, acetophenone, anthraquinone, and thioxanthone.

(3) Silane Compound

The silane compound may include at least one selected from the group consisting of tetraalkoxy silane, trialkoxy silane, and dialkoxy silane.

Tetraalkoxy Silane

The tetraalkoxy silane may include at least one selected from the group consisting of tetramethoxy silane, tetraethoxy silane, tetra-n-propoxy silane, tetra-i-propoxy silane, and tetra-n-butoxy silane.

Trialkoxy Silane

The trialkoxy silane may include at least one selected from the group consisting of methyl trimethoxy silane, methyl triethoxy silane, ethyl trimethoxy silane, ethyl triethoxy silane, n-propyl trimethoxy silane, n-propyl triethoxy silane, i-propyl trimethoxy silane, i-propyl triethoxy silane, n-butyl trimethoxy silane, n-butyl triethoxy silane, n-pentyl trimethoxy silane, n-hexyl trimethoxy silane, n-heptyl trimethoxy silane, n-octyl trimethoxy silane, vinyl trimethoxy silane, vinyl triethoxy silane, cyclohexyl trimethoxy silane, cyclohexyl triethoxy silane, phenyl trimethoxy silane, phenyl triethoxy silane, 3-chloropropyl trimethoxy silane, 3-chloropropyl triethoxy silane, 3,3,3-trifluoropropyl trimethoxy silane, 3,3,3-trifluoropropyl triethoxy silane, 3-aminopropyl trimethoxy silane, 3-aminopropyl triethoxy silane, 2-hydroxyethyl trimethoxy silane, 2-hydroxyethyl triethoxy silane, 2-hydroxypropyl trimethoxy silane, 2-hydroxypropyl triethoxy silane, 3-hydroxypropyl trimethoxy silane, 3-hydroxypropyl triethoxy silane, 3-mercaptopropyl trimethoxy silane, 3-mercaptopropyl triethoxy silane, 3-isocyanate propyl trimethoxy silane, 3-isocyanate propyl triethoxy silane, 3-glycidoxy propyl trimethoxy silane, 3-glycidoxy propyl triethoxy silane, 2-(3,4-epoxycylohexyl)ethyl trimethoxy silane, 2-(3,4-epoxycyclohexyl)ethyl triethoxy silane, 3-(meth)acryloxypropyl trimethoxy silane, 3-(meth)acryloxypropyl trimethoxy silane, 3-(meth)acryloxypropyl triethoxy silane, 3-ureidopropyl trimethoxy silane, and 3-ureidopropyl triethoxy silane.

Dialkoxy Silane

The dialkoxy silane may include at least one selected from the group consisting of dimethyl dimethoxy silane, dimethyl diethoxy silane, diethyl dimethoxy silane, diethyl diethoxy silane, di-n-propyl dimethoxy silane, di-n-propyl diethoxy silane, di-i-propyl dimethoxy silane, di-i-propyl diethoxy silane, di-n-butyl dimethoxy silane, di-n-butyl diethoxy silane, di-n-pentyl dimethoxy silane, di-n-pentyl diethoxy silane, di-n-hexyl dimethoxy silane, di-n-hexyl diethoxy silane, di-n-heptyl dimethoxy silane, di-n-heptyl diethoxy silane, di-n-octyl dimehoxy silane, di-n-octyl diethoxy silane, di-n-cyclohexyl dimethoxy silane, di-n-cyclohexyl diethoxy silane, diphenyl dimethoxy silane, and diphenyl diethoxy silane.

(4) Thermoplastic Resin

The thermoplastic resin may include at least one selected from the group consisting of polystyrene, polystyrene derivative, polystyrene butadiene copolymer, polycarbonate, polyvinyl chloride, polysulfone, polyether sulfone, polyether imide, polyacrylate, polyester, polyimide, polyamic acid, cellulose acetate, polyamide, polyolefin, polymethyl methacrylate, polyether ketone, and polyoxy ethylene.

(5) Conductive Polymer

The conductive polymer may include at least one selected from the group consisting of polythiophene polymer, polythiophene copolymer, polyacetylene, polyaniline, polypyrrole, poly(3,4-ethylenedioxythiophene), and pentacene compound.

The step (c) may further include adding at least one additive selected from the group consisting of proteins, amino acids, fats, polysaccharides, monosaccharides, glucose, vitamins, fruit acids, surfactants, dispersing agents, BYK, functional components, solvents, oils, dispersants, acids, bases, salts, ions, labeling agents, cohesive agents, oxides, ceramics, magnetic materials, organic materials, biomaterials, plate type materials, nano-scale plate type materials, nanoparticles, nanowires, carbon nanotubes, nanotubes, ceramic nano-powder, quantum dots, zero-dimensional materials, one-dimensional materials, two-dimensional materials, hybrid materials, organic-inorganic hybrid materials, inks, pastes, and plant extracts.

Out of the additives, nano-scale plate type materials, nanoparticles, nanowires, carbon nanotubes, nanotubes, ceramic nano-powder, etc. are used to provide additional compensation (additional extension of interface, filling of empty spaces, etc.) for the issue of step difference that occurs due to an interplanar overlap of the first plate type material.

More specifically, for example, the nanoparticles are used to fill the spaces formed by the step difference occurring due to an interplanar overlap of the plate type material; and the nanowires (e.g., silver nanowires, copper nanowires, etc.) are used to extend the interface length of the step difference portion.

In order to further enhance the properties of the two-dimensional hybrid plate type material, there may be used a dispersing agent to enhance the efficiency of hybridization and a binder to enhance the coating properties (i.e., preventing the film packing and getting loose), which additives can be used in combination. These additives serve to maximize the contact area between the materials, increase the density, and thereby enhance the properties of the hybrid composite.

The additives available to enhance dispersion stability and coating properties and to manufacture composites may also be used in combination. Those additives include surfactants, dispersing agents, BYK, solvents, oils, dispersants, acids, bases, salts, ions, labeling agents, cohesive agents, oxides, ceramics, magnetic materials, organic materials, biomaterials, etc. and may be used alone or in combination. Of course, the additives may be used in combination with the zero-dimensional nanomaterial, the one-dimensional nanomaterial, or the third plate type material (i.e., two-dimensional nanomaterial). Particularly, metal nanoparticles, metal nanowires (e.g., silver nanowires, copper nanowires, etc.), metal nanoflakes, carbon nanotubes (CNT), and so forth may be used to enhance the electrical conductivity of the coating material.

Out of the additives, solvents (e.g., organic solvents, amphoteric solvents, water-soluble solvents, hydrophilic solvents, etc.), oils, dispersants, acids, bases, salts, ions, labeling agents, cohesive agents, or the like are used to enhance dispersability, coatability, stability, adhesion, labeling properties, viscosity, properties of coating films, dry properties, etc.

Further, oxides, ceramics, magnetic materials, carbon nanotubes, etc. are used to further acquire the functionality of the hybrid composite.

Below is a detailed description given as to the different materials available as additives.

(1) Metal Nanowire

The metal nanowires may include copper nanowires or silver nanowires. An addition of the metal nanowires can enhance the electrical conductivity of the coating material. The copper (Cu) nanowires as used herein may be coated with a protective film, which is made up of a polymer or a metal.

(2) Dispersing Agent

The dispersing agents may include at least one selected from the group consisting of BYK, block copolymer, BTK-Chemie, triton X-100, polyethylene oxide, polyethylene oxide-polypropylene oxide copolymer, polyvinyl pyrrole, polyvinyl alcohol, Ganax, starch, monosaccharide, polysaccharide, dodecyl benzene sulfate, sodium dodecyl benzene sulfonate (NaDDBS), sodium dodecyl sulfonate (SDS), cetyltrimethyl ammonium 4-vinylbenzoate, pyrene derivatives, gum Arabic (GA), and nafion.

(3) Surfactant

The surfactants may include at least one selected from the group consisting of lithium dodecyl sulfate (LDS), cetyltrimethyl ammonium chloride (CTAC), dodecyl trimethyl ammonium bromide (DTAB), nonionic C12E5 (pentaoxoethylenedocyl ether), dextrin (polysaccharide), polyethylene oxide (PEO), gum Arabic (GA), and ethylene cellulose (EC).

4. Step (d)

This step is solidifying the composite formed by the steps (a), (b) and (c). In the step (d), pressure is applied to the composite to further induce the planar contact or promote the spatial interplanar actions.

For example, performing extrusion molding or compression molding on the powder-type composite prepared from a mixture of first and second plate type materials and a binder can further promote the spatial interplanar actions (i.e., distance, etc.) than preparing a melt composite in a simple way.

Hereinafter, the present invention will be described in further detail with reference to the following examples and comparative examples, which are given for the understanding of the present invention and not intended to limit the scope of the present invention.

### Example 1

An approach to preparation of a graphite oxide may involve the Hummers' method including modified Hummers' method, Brodie method, Hofman & Frenzel method, Hamdi method, Staus method, etc.

In this specification, the modified Hummers' method is employed. More specifically, 50 g of micro-graphite powder and 40 g of NaNO₃ are added to 200 mL of H₂SO₄ solution, and while cooling down, 250 g of KMnO₄ is gradually added to the mixture for one hour. 5 L of 4-7% H₂SO₄ solution is gradually added, and then H₂O₂ is added. After a subsequent centrifugal separation, the precipitate thus obtained is washed with 3% H₂SO₄—0.5% H₂O₂ and distilled water to yield a yellowish brown aqueous graphene slurry.

### Example 2

To describe the chemical reduction method specifically, 2 g of 3% GO slurry is added to 100 ml of distilled water to get a uniform dispersion. After adding 1 ml of hydrazine hydrate, the graphene slurry is subjected to reduction at 100° C. for 3 to 24 hours. The reduced graphene in black is filtered out through a filter paper and then washed with water and methanol. Before applying a strong reducing agent such as hydrazine hydrate, a salt of alkali metal or alkaline earth metal, such as Kl or NaCl, can be added to remove the GO of H₂O, partly recovering the carbon-carbon double bond.

In a more specific experiment, 6 g of Kl is added to 5% GO, and the mixture is kept for 6 days to complete the reaction. Then, the mixture is washed with distilled water and subjected to filtration. Beside the hydrazine or Kl method, there may also be used other methods of adding a reducing agent to the aqueous GO solution, where the reducing agent as used herein includes NaBH₄, pyrogallol, Hl, KOH, Lawesson's reagent, vitamin C, ascorbic acid, etc.

### Example 3

The aqueous graphene slurry obtained in Example 1 is subjected to heat treatment at above 300° C. to yield a graphene powder. In the present invention, the heat treatment at 600° C. is carried out in the nitrogen inert gas atmosphere for 10 minutes to prepare a thermoreduction graphene powder.

### Example 4

GIC commercially available is exposed to microwave for 30 seconds to obtain EP, which is then subjected to sonication for 30 minutes to yield CNP. In another process, GIC is instantaneously heated at 500° C. in the inert gas atmosphere to form EP, which is then subjected to sonication for 30 seconds to yield CNP. The thickness is in the range of 5 to 100 nm as observed with a transmission electron microscope. Actually, CNP is partly incorporated into the EP obtained in the intermediate step of the present invention, so the EP can be included in the present invention. In this case, without the separate sonication step, the EP-state CNP and other plate type materials, that is, graphene or graphite are mixed together and then exposed to molecule-scale shock waves, for example, under sonication-assisted dispersion to prepare a two-dimensional hybrid material.

### Example 5

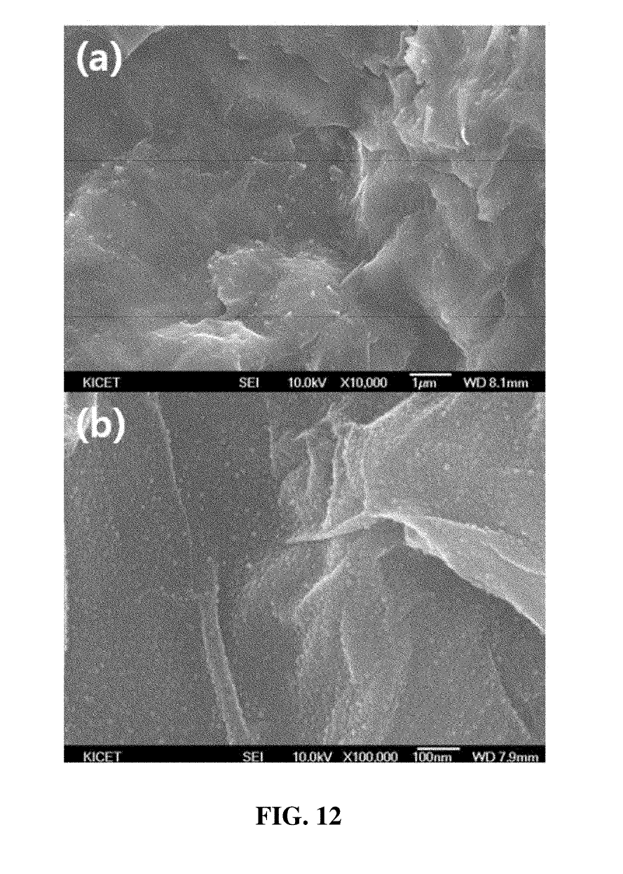

FIG. 12 is an electron microscopic image showing that nanoparticles are applied to decorate the surface of graphene used as a first plate type material and CNP used as a second plate type material. As for the first plate type material, a silver-based organic metal compound is applied to attach the nanoparticles to graphene by the liquid reduction method. As for the second plate type material, a nickel-based organic metal compound is adsorbed onto the surface of the CNP and then subjected to heat treatment. When these materials are mixed together at a mixing ratio of 8.5:1.5 (CNP:graphene) and dispersed, a novel magnetic material is acquired with considerably reduced sheet resistance to 3.5 Ω/sq. In the magnetism measurement using coercive force, the coercive force is 150 e, and the percentage of remanent magnetization with respect to saturation magnetization is 3.7%. This reveals that a hybrid film with magnetic properties and good electric conductivity can be obtained according to the principle of the present invention.

### Example 6

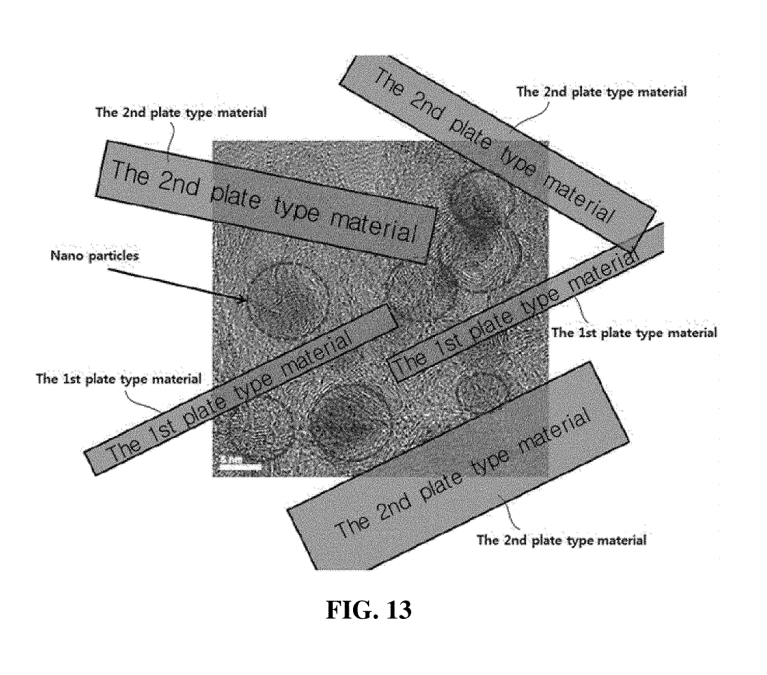

0.5% of silver nanoparticle is subjected to sonication-assisted dispersion in a CNP (85%)-graphene (15%) hybrid material and then a coating process. The coating film thus obtained is measured in regards to the sheet resistance, which is about 2 Ω/sq as enhanced about four times or greater. This reveals that the silver nanoparticle plays an important role in solving the problem of step difference that appears in the plate type materials. In other words, the silver nanoparticle presumably enhances the filling rate (not the contact area) in the interface and individually gets dispersed in the gaps of the plate type materials as can be seen from the transmission electron microscopic image of FIG. 13.

### Example 7

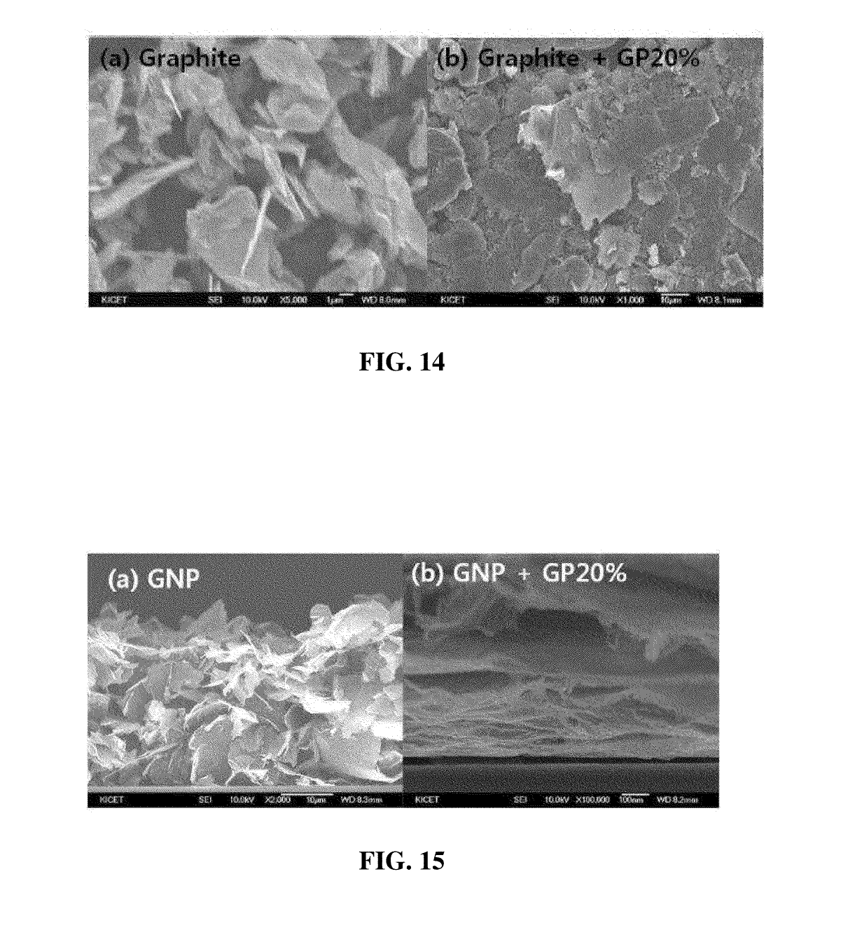

The CNP-graphite composite material obtained in Example 4 is mixed with IPA. After a sonication-assisted dispersion process for 30 seconds, the electrical conductivity by weight content is measured. The measurement results are presented in Table 1 (top). It is interesting that the resistance of the flake carbon-carbon nanoplate hybrid material does not change linearly as a function of the weight content but has a nonlinear change, so it is abruptly decreased when 20% of carbon nanoplate is added. Such a nonlinear change of the resistance can be explained by way of the process of overcoming the problems in regards to step difference and wrinkles as described in the present invention. In other words, the thin and flexible carbon nanoplate contributes to a great increase in the contact area of the step difference portion that appears in the flake carbon. In addition, as can be seen from FIG. 14, the gaps and rough surfaces (in the left-sided part of FIG. 14) of the flake carbon become smooth (in the right-sided part of FIG. 14) with the progress of the two-dimensional hybridization. Even after conducting a compression, the electrical resistance greatly increases, and its increment is greatly fluctuating according to the hybridization effect of the present invention. The following Table 1 shows the measurement results after adding 10% of epoxy resin as a third binder and after conducting a compression. Interestingly, the results disclose the fact that the resistance of the flake carbon-carbon nanoplate hybrid material does not change linearly as a function of the weight content but abruptly decreases in a nonlinear way when 20% of carbon nanoplate is added. Such a nonlinear change in resistance can be explained by way of the process of overcoming the problems in regards to step difference and wrinkles as described in the present invention. Further, even without a direct interplanar bonding, the spatial interplanar action is considerably significant and becomes more effective after compression.

TABLE 1

| Weight | Flake carbon | 100 | 80 | 60 | 40 | 20 | 0 |
|---|---|---|---|---|---|---|---|
| content (%) | Carbon | 0 | 20 | 40 | 60 | 80 | 100 |
| | nanoplate | | | | | | |
| Sheet resistance (Ω/sq, | | 200 | 80 | 60 | 55 | 40 | 30 |
| thickness 20) | | | | | | | |
| Compression (1 ton/) | | 188 | 65 | 49 | 37 | 31 | 24 |
| Weight | Flake carbon | 100 | 80 | 60 | 40 | 20 | 0 |
| content (%) | Carbon | 0 | 20 | 40 | 60 | 80 | 100 |
| | nanoplate | | | | | | |
| | Epoxy resin | 10 | 10 | 10 | 10 | 10 | 10 |

| | | | | | | |
|---|---|---|---|---|---|---|
| Sheet resistance (Ω/sq, | 30,000 | 700 | 550 | 490 | 370 | 260 |
| thickness 20) | | | | | | |
| Compression (1 ton/) | 25,000 | 555 | 510 | 423 | 312 | 199 |

### Example 8

A composite material of the graphene obtained in Example 2 and graphite is mixed with IPA. After a sonication-assisted dispersion process for 30 seconds, the electrical conductivity by weight content is measured. The measurement results are presented in Table 2. It is interesting that the resistance of the flake carbon-graphene hybrid material does not change linearly as a function of the weight content but has a nonlinear change, so it is abruptly decreased when 20% of graphene is added. Such a nonlinear change of the resistance can be explained by way of the process of overcoming the problem in regards to step difference as described in the present invention. In other words, the thin and ultra-high flexible graphene contributes to a great increase in the contact area of the step difference portion that appears in the flake carbon.

Compared with the case of using carbon nanoplate, this case has a nonlinear behavior more fluctuating (desirably). This can be explained by the electrical conductivity and ultra-high flexibility of the graphene. In addition, as can be seen from FIG. 15, the gaps and rough surfaces (in the left-sided part of FIG. 15) of the carbon nanoplate become smooth (in the right-sided part of FIG. 15) with the progress of two-dimensional hybridization. The effects of the present invention as a result of compression and addition of a polymer appear in the same manner as described in Example 7.

TABLE 2

| Weight content | Flake carbon | 100 | 80 | 60 | 40 | 20 | 0 |
|---|---|---|---|---|---|---|---|
| (%) | Graphene | 0 | 20 | 40 | 60 | 80 | 100 |
| Sheet resistance (Ω/sq, | | 200 | 30 | 19 | 14 | 9 | 5 |
| thickness 20) | | | | | | | |
| Compression (1 ton/) | | 154 | 24 | 15 | 11 | 6 | 3 |
| Weight content | Flake carbon | 100 | 80 | 60 | 40 | 20 | 0 |
| (%) | Graphene | 0 | 20 | 40 | 60 | 80 | 100 |

| | | | | | | |
|---|---|---|---|---|---|---|
| Sheet resistance (Ω/sq, | 13,500 | 289 | 134 | 110 | 89 | 45 |
| thickness 20) | | | | | | |
| Compression (1 ton/) | 11,000 | 230 | 99 | 76 | 55 | 39 |

### Example 9

A composite material of the graphene obtained in Example 2 and the CNP obtained in Example 2 is mixed with IPA. After a sonication-assisted dispersion process for 30 seconds, the electrical conductivity by weight content is measured. The measurement results are presented in Table 3. It is interesting that the resistance of the carbon nanoplate-graphene hybrid material does not change linearly as a function of the weight content but has a nonlinear change, so it is abruptly decreased when 20% of graphene is added. Such a nonlinear change of the resistance can be explained by way of the process of overcoming the problem in regards to step difference as described in the present invention. In other words, the thin and ultra-high flexible graphene contributes to a great increase in the contact area of the step difference portion that appears in the carbon nanoplate.

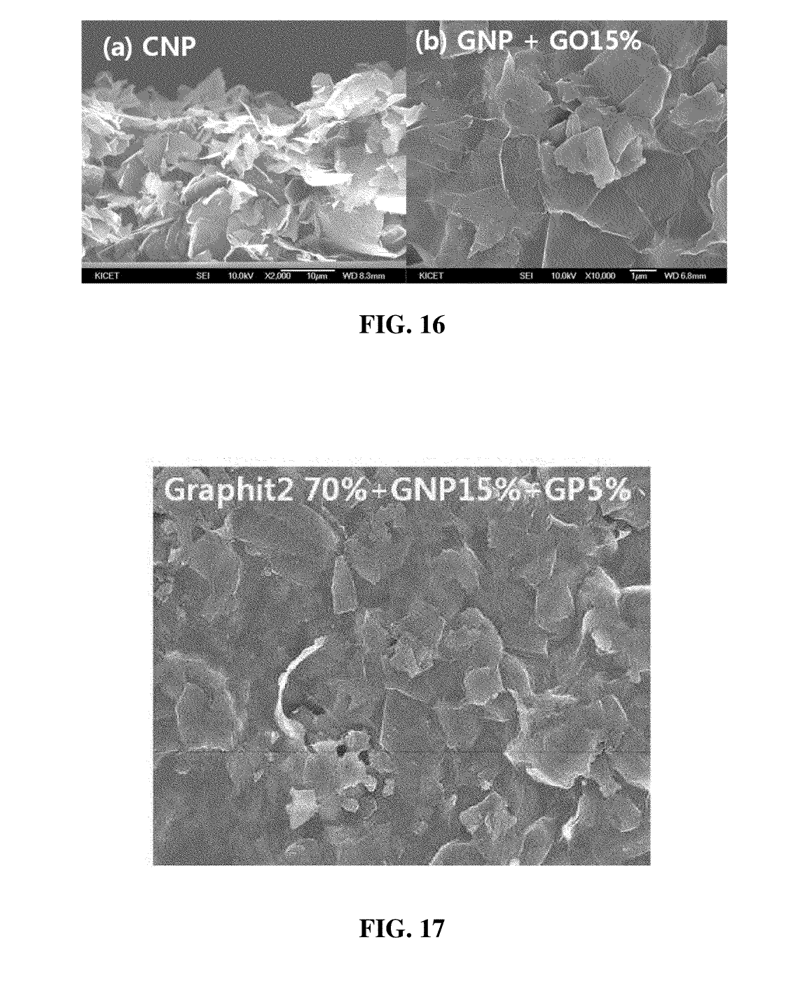

In addition, this example shows that the step difference is found in the relatively thin carbon nanoplate with respect to the flake carbon and overcome by the use of graphene, which is thinner and more flexible. According to this principle, any other material (e.g., metal nanoplate) that is as thin and good in conductivity as graphene can be used in place of graphene. To enhance solid lubricants rather than conductivity, there can be used a combination, such as carbon nanoplate-WS₂ nanoplate, MoS₂ nanoplate-graphene, graphite-WS₂ nanoplate-graphene, or MoS₂ nanoplate-graphite. To enhance photocatalysts, MoS₂ nanoplate-TiO₂ nanoplate can be used. In other words, the keyword of the present invention is thickness and flexibility. The modifications of the nanoplate material (i.e., hybrid materials) are available according to the desired properties, so the present invention can solve the problem of step difference that appears in various two-dimensional plate type materials. For example, FIG. 16 shows a hybridization of three different plate type materials. The effects of the present invention as a result of compression and addition of a polymer appear in the same manner as described in Examples 7 and 8.

TABLE 3

| Weight content | Carbon nanoplate | 100 | 80 | 60 | 40 | 20 | 0 |
|---|---|---|---|---|---|---|---|
| (%) | Graphene | 0 | 20 | 40 | 60 | 80 | 100 |
| Sheet resistance (Ω/sq, | | 200 | 21 | 15 | 11 | 7 | 5 |
| thickness 20) | | | | | | | |
| Compression (1 ton/) | | 188 | 19 | 13 | 9 | 6 | 4 |
| Weight content | Carbon nanoplate | 100 | 80 | 60 | 40 | 20 | 0 |
| (%) | Graphene | 0 | 20 | 40 | 60 | 80 | 100 |
| | PVA | 3 | 3 | 3 | 3 | 3 | 3 |

| | | | | | | |
|---|---|---|---|---|---|---|
| Sheet resistance (Ω/sq, | 679 | 123 | 96 | 23 | 15 | 11 |
| thickness 20) | | | | | | |
| Compression (1 ton/) | 543 | 89 | 76 | 19 | 9 | 6 |

### Example 10

A three-component composite material consisting of the graphene of Example 2, the CNP of Example 2 and graphite is mixed with IPA. After a sonication-assisted dispersion process for 30 seconds, the electrical conductivity by weight content is measured. The measurement results are presented in Table 4. It is interesting that the three-component (flake carbon-carbon nanoplate-graphene) hybrid plate type material contains a very small amount of graphene but exhibits pretty good properties more excellent than the behaviors of Table 1. This shows that the problem of step difference that appears in graphite flake or carbon nanoplate can be solved with efficiency. It is thus expected to yield a hybrid material with very excellent properties through the modifications of the process conditions and composition. It is thus apparent that the hybridization of at least three components is available and effective. Further, a third plate type material and a fourth plate type material can be available and added. As for the electrical conductivity, the use of metal nanoplate (metal nanoflake) can be a great help to enhance the properties. The behaviors after compression and addition of a polymer are expected to be the same as described in Example 9.

TABLE 4

| | | | | | | | |
|---|---|---|---|---|---|---|---|
| Weight content | Flake carbon | 95 | 90 | 85 | 80 | 75 | 70 |
| (%) | Carbon nanoplate | 5 | 5 | 10 | 15 | 20 | 25 |
| | Graphene | 0 | 5 | 5 | 5 | 5 | 5 |

| | | | | | | |
|---|---|---|---|---|---|---|
| Sheet resistance (Ω/sq, thickness 20) | 100 | 78 | 61 | 42 | 31 | 19 |

### Example 11

The graphite (80%)-carbon nanoplate (15%)-graphene oxide (5%) hybrid plate type material has a sheet resistance of 39 Ω/sq, as shown in Table 4. With the weight ratio of this three-component hybrid material being 80%, 15% of silver nanowire (30 nm in diameter, 5 micron long) and 5% of 30 nm-diameter silver nanoparticle are subjected to sonication-assisted dispersion and coating. The film thus obtained is measured in regards to the sheet resistance, which is about 1 Ω/sq, showing that the electrical conductivity is enhanced about more than about 40 times. This reveals that silver nanowire and silver nanoparticle play an important role in solving the problem of step difference that appears in the plate type materials. In other words, the silver nanoparticle serves to extend the contact length (not the contact area) in the interface. The nanowire can be used to compensate for the problem concerning the contact length (particularly important in the case of conductivity) in the interface of the nanoplate. When used to enhance the electrical conductivity, the nanowire is a metal nanowire, such as silver nanowire or copper nanowire, and carbon nanotube is also available. Further, the nanoparticle does an important role to fill the empty spaces that appear due to the step difference. Thus, other nanoparticles and nanowires can be used to further compensate for the second problems in the two-dimensional hybrid material. For reference, it is very difficult to make a thick film with silver nanowire and silver nanoparticle alone (due to sand-like property), so the present invention uses these materials in association with the thin film properties and thick film properties of two-dimensional plate type materials (excellent in formation of multilayer type coating films due to the planar structure) to additionally acquire good novel properties. FIG. 17 is an FE-SEM image of a material prepared by adding silver nanowire and silver nanoparticle to the graphite-carbon nanoplate-graphene oxide hybrid plate type material.

### Example 12

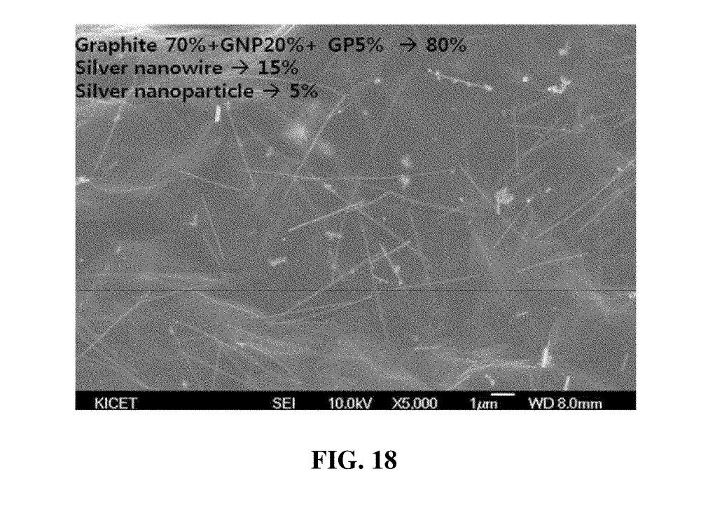

In order to make a more stable film with a graphite (80%)-carbon nanoplate (15%)-graphene oxide (5%) hybrid plate type material, a BYK-series dispersing agent and a PVP binder are added in the IPA dispersion process (sonication) to form a film. It can be seen that the dispersing agent is used to achieve a more uniform hybridization of the nano-scale plate type materials each having a different thickness, and a small amount of the binder is added to acquire high density in packing the film. These additives can be a help to solve the additional problems in the two-dimensional hybrid material. FIG. 18 is an FE-SEM image of a material prepared by adding a dispersing agent to the graphite-carbon nanoplate-graphene oxide hybrid plate type material.

### Example 13

For graphene oxide as a first plate type material and carbon nanoplate as a second plate type material, an experiment is conducted to evaluate the effect of the content. A composite material of the CNP obtained in Example 4 and the graphene oxide (GO) obtained in Example 1 is mixed with IPA. After a sonication-assisted dispersion process for 30 seconds, the electrical conductivity by weight content is measured. The measurement results are presented in Table 5. The heat treatment is conducted at 200 to 500° C. It is interesting that the resistance of the carbon nanoplate-graphene oxide hybrid material does not change linearly as a function of the weight content but abruptly decreases in a nonlinear way when 5% of carbon nanoplate is added. Such a nonlinear change in the resistance can be explained by way of the process of overcoming the problems in regards to step difference and wrinkles as described in the present invention. In other words, the thin and flexible graphene oxide contributes to a great increase in the contact area of the step difference portion in the CNP. The CNP (60%)-graphene oxide (40%) hybrid material has the lowest resistance of 6 Ω/sq, while the resistance is 25 Ω/sq for graphene oxide used as the first plate type material and 20 Ω/sq for CNP as the second plate type material. This resistance value demonstrates the effectiveness of the present invention and is considered as the best value in the world for the existing coatings of a thick film without a binder. It is therefore expected to acquire more excellent properties when optimizing the solvents, the dispersion process, the coating process, etc. on the basis of this example of the present invention. It can be seen from Table 5 that the CNP content of 60% or less is likely to deteriorate the properties so that the effective contacts are saturated, with the remaining graphene functioning as a defect like a foreign material. The behaviors after compression and addition of a polymer are expected to be the same as described in Examples 7, 8 and 9.

TABLE 5

| | | | | | | | | |
|---|---|---|---|---|---|---|---|---|
| Weight | Carbon nanoplate | 100 | 95 | 85 | 70 | 60 | 55 | 50 |
| content (%) | (20 Ω/sq) | | | | | | | |
| | Graphene oxide | 0 | 5 | 15 | 30 | 40 | 45 | 50 |
| | (insulator -> after heat | | | | | | | |
| | treatment, 20 Ω/sq) | | | | | | | |

| | | | | | | | |
|---|---|---|---|---|---|---|---|
| Sheet resistance (Ω/sq, thickness 20) | 20 | 17 | 14 | 9 | 6 | 7 | 10 |

### Example 14

Graphene oxide used as a first plate type material and carbon nanoplate as a second plate type material are mixed together at a fixed weight content of 15:85, and graphene as a third plate type material is added to complete a hybrid material. An experiment on the hybridization effect is then conducted. The graphene as used herein is the 1-10 layered RGO material obtained in Example 2. It can be seen from Table 6 that the electrical resistance decreases with an increase in the weight content of graphene, which implicitly shows that the step difference of the present invention and the problems with the individual materials are greatly improved. The behaviors after compression and addition of a polymer are expected to be the same as described in Examples 7, 8 and 9.

TABLE 6

| | | | | | | | | |
|---|---|---|---|---|---|---|---|---|
| Weight | Carbon nanoplate (85%)- | 100 | 99 | 95 | 90 | 70 | 50 | 40 |
| content (%) | graphene (15%) (8 Ω/sq) | | | | | | | |
| | Graphene oxide | 0 | 1 | 5 | 10 | 30 | 50 | 60 |
| | (25 Ω/sq) | | | | | | | |

| | | | | | | | |
|---|---|---|---|---|---|---|---|
| Sheet resistance (Ω/sq, thickness 20) | 8 | 7.5 | 6 | 5.1 | 4.2 | 3.1 | 2.5 |

A surface coating can be applied when the binder is added in such a small amount or weak in strength. For example, the first and second plate type materials are mixed by liquid dispersion in the presence of a dispersing agent and applied as a coating film to a substrate. After vacuum drying and heat treatment, the coating film is removed of the dispersing agent and then subjected to a compression to maximize the planar contact. In order to protect the coating film, a resin is applied to the surface of the coating film to form a protective film.

Further, when the binder uses a resin as a principal component, the first and second plate type materials are properly mixed with the binder according to the solid mixing method, whereas a drying process is required in the case of the liquid state; and a natural drying is conducted during the process in the semi-liquid state. Then, an arrangement in one direction is achieved through an injection molding process to yield a stable composite.

Furthermore, when the binder is polymer chip or polymer powder, the first and second plate type materials are adsorbed or attached to the surface of the binder (in the liquid state, or using an electrostatic attraction or van der Waals attraction, etc.) and then subjected to an injection molding process to yield a composite of the present invention with secured orientation and uniformity.

The present invention relates to a method for preparing a two-dimensional hybrid composite that is capable of solving the problems with the two-dimensional plate type materials, that is, step difference, defects, stretching, etc., that occur as the second-dimensional plate type materials overlap with one another, so it is considered to be industrially available.

What is claimed is:

1. A method for preparing a two-dimensional hybrid composite, comprising:
(a) preparing a first plate type material in the solid or liquid state;
(b) mixing a second plate type material with the first plate type material, the second plate type material being thinner and more flexible than the first plate type material;
(c) mixing a solid or liquid binder with the first and second plate type materials to make the first and second plate type materials partly contact with or apart from each other; and
(d) solidifying a composite formed by the steps (a), (b) and (c).

2. The method as claimed in claim 1, wherein the first plate type material is at least one selected from the group consisting of planar ceramic, nanoclay, ZnO nanoplate, TiO₂ nanoplate, WS₂, MoS₂, oxide, clamshell, calcium carbonate, sulfide, metal flake, silver flake, copper flake, carbon flake, carbon nanoplate, graphene, graphene oxide, graphite oxide, a reduced material of graphene oxide, a reduced material of graphite oxide, an electrical exfoliation product of graphite, a physical exfoliation product of graphite, a solvent-based exfoliation product of graphite, a physiochemical exfoliation product of graphite, and a mechanical exfoliation product of graphite.

3. The method as claimed in claim 1, wherein the second plate type material is at least one selected from the group consisting of carbon nanoplate, graphene, and graphene oxide, with a thickness of 200 nm or less.

4. The method as claimed in claim 1, wherein the step (c) further includes adding at least one selected from the group consisting of proteins, amino acids, fats, polysaccharides, monosaccharides, glucose, vitamins, fruit acids, surfactants, dispersing agents, BYK, functional components, solvents, oils, dispersants, acids, bases, salts, ions, labeling agents, cohesive agents, oxides, ceramics, magnetic materials, organic materials, biomaterials, plate type materials, nano-scale plate type materials, nanoparticles, nanowires, carbon nanotubes, nanotubes, ceramic nano-powder, quantum dots, zero-dimensional materials, one-dimensional materials, two-dimensional materials, hybrid materials, organic-inorganic hybrid materials, inks, pastes, and plant extracts.

5. A method for preparing a two-dimensional hybrid composite, comprising:
(a′) preparing a binder; and
(b′) attaching a first plate type material and a second plate type material to the surface of the binder, the second plate type material being thinner and more flexible than the first plate type material.
